(19) United States
(12) Patent Application Publication
(10) Pub. No.: US 2025/0162472 A1
(43) Pub. Date: May 22, 2025

(54) ROLLER

(71) Applicant: GRAMMER Aktiengesellschaft, Ursensollen (DE)

(72) Inventor: Florian SCHANDERL, Schwarzenfeld (DE)

(73) Assignee: GRAMMER Aktiengesellschaft, Ursensollen (DE)

(21) Appl. No.: 18/941,515

(22) Filed: Nov. 8, 2024

(30) Foreign Application Priority Data
Nov. 22, 2023 (DE) 10 2023 132 579.5

(51) Int. Cl. B60N 2/04; F16C 29/04

(52) U.S. Cl. CPC B60N 2/04; F16C 29/04; F16C 2326/08

(57) ABSTRACT

The invention relates to a roller for a roller guide, which is provided in particular in a vehicle seat-base, comprising a first subelement which comprises a rolling surface and a second subelement which forms a mount for a bearing element, wherein the second subelement has a first section which is at least partially enclosed by the first subelement in such a way that there is a positive locking between the first subelement and the second subelement.

### CROSS REFERENCE TO RELATED APPLICATION

This application claims the benefit of German Patent Application No. 10 2023 132 579.5, filed Nov. 22, 2023, the entire contents of which are hereby incorporated herein by reference.

### FIELD

The invention relates to a roller, in particular for a vehicle seat-base, comprising a first subelement which comprises a rolling surface and a second subelement which forms a mount for a bearing element.

### BACKGROUND

Vehicle seats, in particular for use in commercial vehicles, comprise a seat-base, which is provided between an upper vehicle seat section and a lower vehicle seat section. Such a vehicle seat-base may have a scissor-type frame. In order to enable movement during compression or rebound, the scissor-type frame generally comprises fixed bearings and floating bearings. Such a floating bearing also comprises a roller guide with corresponding rollers. These rollers are arranged on a bearing element or bearing pin and roll within a track. The rollers should have good rolling behaviour and cause low friction losses.

Solid rollers made of one material are known in the state of the art. However, as the material should have different requirements when interacting with the running rail as when interacting with the bearing element or bearing pin, a compromise usually has to be made when selecting the material in order to fulfil the conflicting requirements.

### SUMMARY

The object of the present invention is to provide a roller for a vehicle seat-base or a vehicle seat which overcomes the above-mentioned disadvantages.

The object is solved by a roller according to the present description.

The core idea of the invention is a roller, in particular for a vehicle seat-base, comprising a first subelement which comprises a rolling surface and a second subelement which forms a mount for a bearing element, wherein the second subelement has a first section which is at least partially enclosed by the first subelement in such a way that there is a positive locking between the first subelement and the second subelement.

The roller according to the invention is preferably suitable and intended to be used in a roller guide or floating bearing of a vehicle seat-base.

The present invention makes it possible for the first subelement to be optimised with regard to the requirements for good rolling behaviour within the running rail. Likewise, the second subelement can be optimised with regard to the interaction with the bearing element, which can be a bearing pin, for example. The positive locking between the first subelement and the second subelement provides a mechanically stable, uniform roller. It is not necessary, for example, to provide other types of connection, such as a material connection between the first subelements.

According to a preferred embodiment, the first subelement and the second subelement are made of different materials. Preferably, the material of the first subelement is selected such that it has a higher coefficient of friction than the material of the second subelement. Such a coefficient of friction is also referred to as the frictional coefficient and is a parameter for the ratio of frictional force to contact pressure between two bodies. It is advantageous that the material of the first subelement, comprising the rolling surface, has a high coefficient of friction.

Such a high coefficient of friction results in good rolling behaviour, as sliding of the roller in the track is reduced.

However, a low coefficient of friction is desirable for the second subelement, as the second subelement preferably rotates around the bearing element or around the bearing bolt. The friction between the roller and the bearing element should be kept as low as possible in order to ensure that the roller runs smoothly.

Preferably, the two materials of the first subelement and the second subelement have different hardness. Preferably, the material of the second subelement has a greater hardness than the material of the first subelement. With such an advantageous design, the mechanical stability of the roller can essentially be ensured by the second subelement.

According to another preferred embodiment, the first subelement and the second subelement are made of different plastics. Preferably, the roller is manufactured by means of a multi-component injection moulding process. Due to the positive locking according to the invention, a material bond between the two components of the injection moulding process is not necessary to ensure mechanical stability of the roller. The choice of plastics is therefore not limited to those that form a material bond in injection moulding processes.

According to a preferred embodiment, there is no material-to-material bond between the first subelement and the second subelement. However, the invention is not intended to be limited to the fact that no such material bond exists. Rather, it should be emphasised that there is generally no need for such a bond.

Embodiments are therefore also conceivable in which there is an material bond between the first subelement and the second subelement. A material-to-material bond can be formed, for example, by joining the materials during the injection moulding process. However, a material-to-material bond can also be an adhesive bond or a welded bond.

An economical injection moulding process requires the wall thickness of the manufactured components to be as thin as possible. To ensure a high load-bearing capacity of the roller, it is advantageous if the outer diameter of the roller is as large as possible. For low friction losses and good rolling behaviour, it is advantageous if the mount for the bearing element, or the bearing pin, and thus also the bearing element itself has as small a diameter as possible. These requirements result in a large difference between an inner radius (radius of the mount) and an outer radius of the roller. It is therefore necessary to manufacture a component with a very large wall thickness using an injection moulding process. However, such production requires long cycle times and is therefore economically disadvantageous. By designing the roller according to the invention with a first subelement and a second subelement, these two subelements can be designed in such a way that their structures advantageously have a lower constant wall thickness. The manufacture of the roller according to the invention thus requires shorter cycle times and is therefore more economical to manufacture.

It is also possible to manufacture a roller with a larger roller diameter in an economical way. A large roller diameter results in improved roller properties. Preferably, the diameter of the roller (outer diameter) is in a range between 27 mm and 33 mm, preferably in a range between 30 mm and 32 mm, more preferably 31 mm. Preferably, the diameter of the mount of the bearing element is in a range between 11 mm and 14 mm, preferably in a range between 11 mm and 13 mm, more preferably 12 mm.

Preferably, the first subelement and the second subelement have constant wall thicknesses and at the same time the roller has a diameter (outer diameter) in a range between 27 mm and 33 mm, preferably in a range between 30 mm and 32 mm, more preferably at 31 mm.

Preferably, the roller is circular-cylindrical in shape. The roller thus advantageously comprises an extension along a radial axis (R) and a further extension along a height axis (H). The rolling surface extends along a circumferential direction (U) of the roller. The first subelement is preferably located further outwards along the radial axis (R) of the bearing roller than the second subelement.

According to a further preferred embodiment, the roller comprises a centre axis (M) which extends along the height axis (H). Preferably, the roller has a radial sectional axis(S) which extends along the radial axis (R). Preferably, the radial sectional axis(S) extends perpendicular to the centre axis (M). Preferably, an intersection of the radial sectional axis(S) and the centre axis (M) lies at half the height extension of the roller along the height axis (H).

According to a further preferred embodiment, the second subelement is symmetrical with respect to the radial sectional axis(S). Preferably, the first section of the second subelement is symmetrical with respect to the radial sectional axis(S). Such a symmetrical design ensures balanced rolling behaviour of the roller.

According to a further preferred embodiment, the second subelement has a second section that is hollow-cylindrical in shape. Preferably, this second section forms the mount for the bearing element or the bearing pin. Accordingly, the bearing element can advantageously be arranged in this mount. The mount is preferably designed as a continuous bore extending along the height axis (H) in the hollow cylinder-like second section. Alternatively, however, the mount can also be a hole that does not extend completely through along the height axis (H). Preferably, the second section forms an inner surface which surrounds the mount or the bore along a circumferential direction (U) of the roller. Preferably, this inner surface is in contact with the bearing element. Advantageously, the roller rotates around a fixed bearing element. It is thus advantageous to minimise friction between the inner surface of the second section and the bearing element. However, embodiments in which a frictionally connected shaft-hub connection is provided between the roller or the second subelement of the roller and the bearing element should not be excluded. For this purpose, the bearing element is usually rotatably mounted on another element.

According to a further preferred embodiment, the second section of the second subelement has a height extension which essentially corresponds to the height extension of the roller. Thus, the second section of the second subelement advantageously extends over the entire height of the roller.

According to a further preferred embodiment, the first section of the second subelement has an outer subsection extending along the circumferential direction (U) of the roller. Preferably, this outer subsection comprises an upper surface which extends substantially parallel to the rolling surface of the first subelement. Preferably, this upper surface is arranged along the radial axis (R) of the roller closer to the centre axis (M) of the roller than the rolling surface.

According to a further preferred embodiment, the outer lower section is essentially hollow cylindrical in shape. Preferably, the outer subsection has an extension along the height axis (H) of the roller which is smaller than the hollow extension of the roller. Advantageously, the first subelement encloses the outer subsection of second subelement at least partially, preferably completely.

According to a further advantageous embodiment, the outer subsection is connected to the second section by means of a connecting subsection of first section. Preferably, the connecting subsection extends along the radial axis (R). Advantageously, an extension of the connecting subsection along the height axis (H) is smaller than the extension of the outer subsection. The connecting sub-section is preferably web-like. Preferably, the connecting sub-section and the outer sub-section are of integral or one-piece design. Here and in the following, a one-piece design is understood to mean that all sections are manufactured from a single and uniform part.

This is to be distinguished from a one-piece design, in which all sections are not manufactured from a single and uniform part, but are not only firmly connected to each other, but are so intimately connected that they do not appear as several components joined together and in any case can no longer be detached from each other without destroying them in the process.

According to a preferred embodiment, the connecting subsection and the outer subsection of second subelement form the first section of the second subelement. Preferably, this first section has a substantially T-shaped cross-sectional area. Preferably, the first section and the second section of the second subelement form a substantially H-shaped cross-sectional surface. Such a design ensures, on the one hand, mechanical stability of the roller by the first subelement and, on the other hand, positive locking between the first subelement and the second subelement.

According to a further preferred embodiment, at least one intermediate subsection is arranged along the axis (R) between the outer subsection and the second section. Preferably, the at least one intermediate subsection has essentially the same design as the outer subsection. Furthermore, it is advantageous that the outer sub-section is connected to the at least one intermediate sub-section by means of a connecting sub-section. Preferably, the at least one intermediate subsection is also connected to the second section of the second subelement by means of a connecting subsection. Preferably, the at least one intermediate subsection, the upper subsection and the at least one connecting subsection are surrounded by the first subelement. This creates a larger number of intermediate spaces, which are filled by the first subelement, thereby ensuring an improved positive locking.

According to a further preferred embodiment, the first subelement has a rolling subsection extending along the circumferential direction (U) of the roller, which comprises the rolling surface. Preferably, the rolling subsection is arranged at least partially on the upper surface of the first subsection.

According to a further preferred embodiment, the first subelement has at least one pair of engagement sections opposite each other along the height axis (H). Preferably, the engagement sections of a pair are separated from each other by a connecting subsection of the second subelement. Advantageously, one engagement section in each case lies along the radial axis (R) between the outer subsection and the second section of the second subelement or between the outer subsection and an intermediate subsection or between an intermediate subsection and the second section of the second subelement or between two intermediate subsections.

Preferably, the second subelement or the first section of the second subelement thus comprises at least one connecting subsection of first section.

According to a further preferred embodiment, at least the rolling subsection, the engagement sections and the outer subsection have essentially the same wall thickness. Preferably, a wall thickness of the rolling subsection, the engagement sections and the outer subsection extends along the radial axis (R) of the roller.

Preferably, at least the rolling subsection, the engagement sections, the outer subsection and the at least one intermediate subsection have substantially the same wall thickness. Preferably, a wall thickness of the rolling subsection, the engagement sections, the outer subsection and the at least one intermediate subsection extends along the radial axis (R).

Preferably, at least the rolling subsection, the engagement portions, the outer subsection and the at least one connecting subsection have substantially equal wall thicknesses. Preferably, a wall thickness of the rolling subsection, the engagement sections, the outer subsection and the at least one intermediate subsection extends along the radial axis (R). Preferably, a wall thickness of the at least one connecting subsection extends along the height axis (H).

Preferably, at least the rolling subsection, the engagement subsections, the outer subsection, the at least one intermediate subsection and the at least one connecting subsection have a substantially equal wall thickness. Preferably, a wall thickness of the rolling subsection, the engagement sections, the outer subsection and the at least one intermediate subsection extends along the radial axis (R). Preferably, a wall thickness of the at least one connecting subsection extends along the height axis (H).

Due to the essentially equal wall thicknesses of the individual components of the roller, the cycle time in the injection moulding process for manufacturing the roller can be shortened or optimised. Instead of a solid roller as in the prior art, it is therefore advantageous to produce a roller that comprises several components in the form of the two first subelements with a defined wall thickness.

According to a further preferred embodiment, the second section of the second subelement has two opposite end regions along the height axis (H). Preferably, each of the end regions is step-like. Advantageously, the step is directed outwards. Preferably, the first subelement rests against the step-like end regions. Such a design improves the positive locking between the first subelement and the second subelement.

The present object is also solved by a vehicle seat-base with a roller guide comprising at least one roller according to at least one of the embodiments described above. The vehicle seat-base can be equipped with all the features already described above in the context of the roller, either individually or in combination with one another, and vice versa.

The present object is also solved by a vehicle seat with a vehicle seat-base solved.

Further advantages, objectives and features of the present invention are explained with reference to the following description of the attached figures. Similar components may have the same reference signs in the various embodiments.

### BRIEF DESCRIPTION OF THE DRAWINGS

FIG. 1 a perspective view of embodiments of the rollers;

FIG. 2 a side view of embodiments of the rollers;

FIG. 3 a sectional view corresponding to the sectional line B-B of a roller from FIG. 2;

FIG. 4 a sectional view corresponding to the sectional line C-C of a roller from FIG. 2;

FIG. 5 a sectional view of a roller according to one embodiment;

FIG. 6 a sectional view of a roller according to one embodiment;

FIG. 7 a sectional view of a roller according to one embodiment;

FIG. 8 a sectional view of a roller according to one embodiment;

FIG. 9 a perspective view of a vehicle seat-base and

FIG. 10 a front view of a vehicle seat-base;

### DETAILED DESCRIPTION

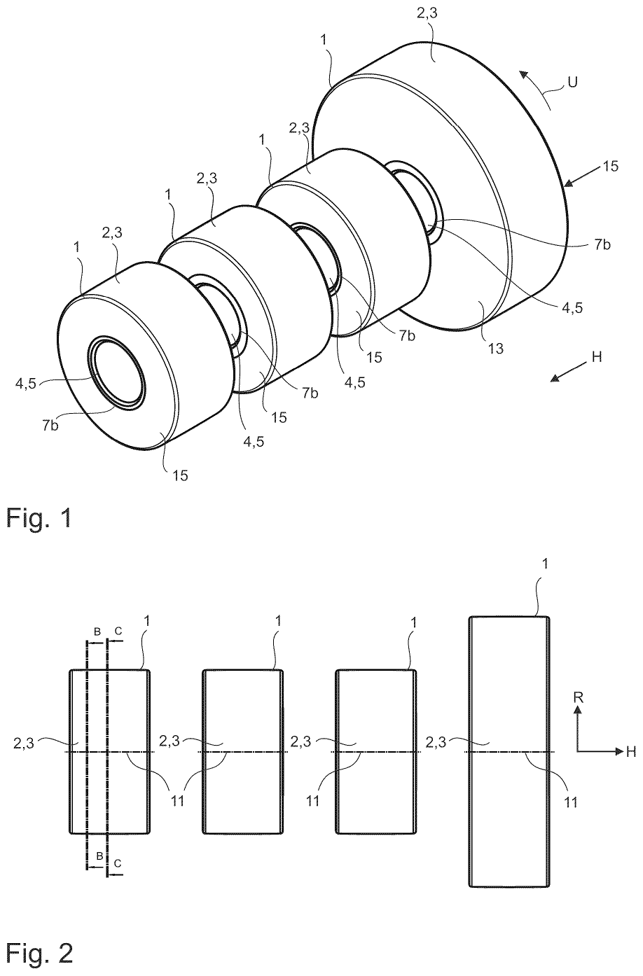

FIGS. 1 to 8 show a roller 1, in particular for a vehicle seat-base (100). The roller 1 comprises a first subelement 2, which comprises a rolling surface 3 and a second subelement 4, which forms a mount 5 for a bearing element 102, wherein the second subelement 4 has a first section 6, which is at least partially enclosed by the first subelement 2 in such a way that a positive locking exists between the first subelement 2 and the second subelement 4.

The first subelement 2 and the second subelement 4 are preferably made of different materials. The material of the first subelement 2 advantageously has a large coefficient of friction in order to ensure good rolling behaviour. The material of the second first subelement 4 preferably has a greater hardness in order to ensure the mechanical stability of the roller 1. Furthermore, the material of the second subelement 4 has a lower coefficient of friction in order to minimise friction between the bearing element 102, in the form of a bearing pin, and the second subelement. Advantageously, the bearing roller 1 is manufactured using a multi-component injection moulding process.

FIG. 1 shows a perspective top view of various embodiments of rollers 1. A corresponding side view of this roller 1 is shown in FIG. 2.

The roller 1 is essentially circular cylindrical in shape. This means that the roller 1 extends along a height axis H and along a radial axis R. Furthermore, a circumferential direction U is defined, which extends along the circumference of the circular base surface.

The roller 1 further comprises a centre axis M, which extends along a height axis H. Furthermore, a radial sectional axis S of the roller 1 can be defined, which extends along the radial axis R of the roller 1. An intersection SP of the radial sectional axis S and the centre axis M lies at half the height extension of the roller 1, whereby the radial sectional axis S is perpendicular to the centre axis M. The first section 6 of the second subelement 5 is symmetrical with respect to the radial sectional axis S.

The second subelement 4 has a second section 7, which is hollow-cylindrical in shape. The second section 7 thus comprises a bore which serves as a mount 5 for the bearing element 102. The second section 7 comprises an inner surface 7a, which contacts the bearing element 102.

Furthermore, the second section of the second subelement has a height extension that corresponds to the height extension of the roller 1. This means that the second section extends along the entire height of the roller 1.

FIG. 1 shows that the roller 1 has two side faces 15. The two side faces 15 are opposite each other along the height axis H. Furthermore, the side faces 15 are each formed by a front face 7b of the second section 7 of the second subelement 4 and by a front face 2a of the first subelement 2. The respective front faces 7b, 2a are adjacent to each other and form a flat front face 15.

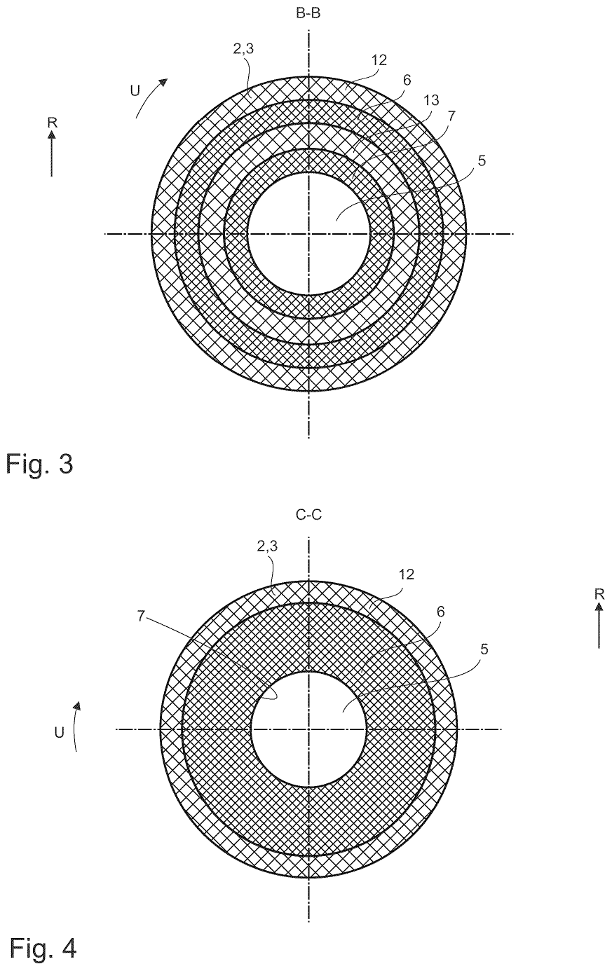

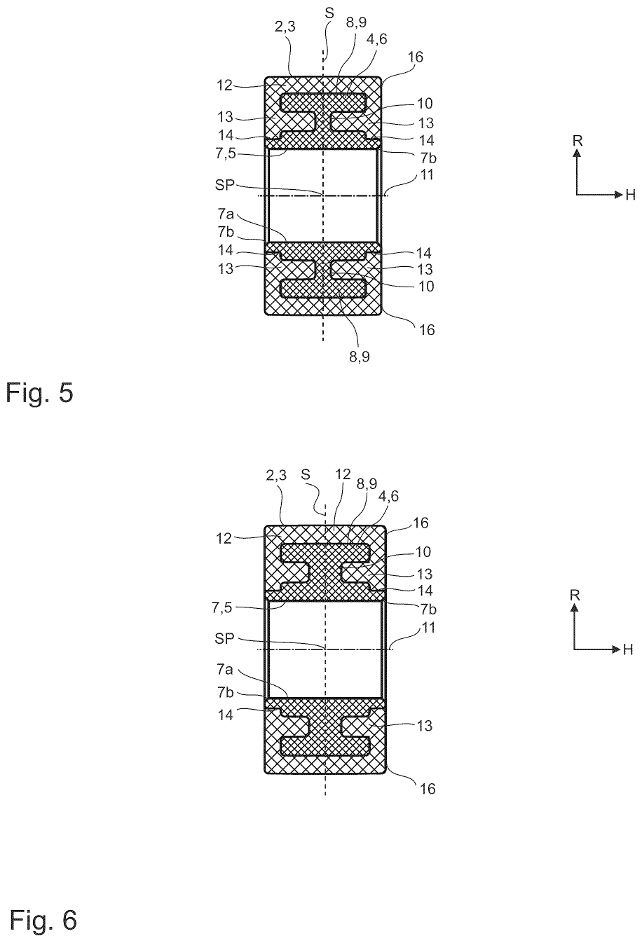

FIGS. 3 to 8 show the structure of the roller 1. FIGS. 5 to 8 show in particular the structure of the second subelement 4 and the surrounding first subelement 2. FIGS. 5, 6, 7, 8 show the different designs of the second subelement 4.

According to each of the embodiments of FIGS. 5 to 8, the first section 6 of the second subelement 4 comprises an outer subsection 8 extending along a circumferential direction U of the roller 1. This subsection 8 comprises an upper surface 9 extending substantially parallel to the rolling surface 3 of the first subelement 2. Furthermore, the upper surface 9 is located along the radial axis R of the roller 1 closer to the centre axis M of the roller 1 than the rolling surface 3.

The outer sub-section 8 is essentially hollow-cylindrical in shape and also merges integrally into a connecting sub-section 10. The outer subsection 8 has an essentially rectangular cross-sectional area. Furthermore, the outer subsection 8 has an extension along the height axis H of the roller 1 which is smaller than the height extension of the roller 1. The outer subsection 8 is arranged in the centre of the roller 1 along the height axis H.

The connecting subsection 10 is also arranged in the centre with respect to an extension of the roller 1 along the height axis H. Similarly, the connecting subsection 10 is arranged in the centre of the outer subsection 8 along the height axis H. The outer subsection 8 and the connecting subsection 10 together have a substantially T-shaped cross-sectional area and are also arranged symmetrically with respect to the radial sectional axis S. The first subelement 2 at least partially encloses the outer subsection 8. The first subelement 2 encloses the outer subsection 8 except for the area which merges into the connecting subsection 10.

According to the embodiments according to FIGS. 5, 6 and 7, the connecting subsection 10 merges integrally into the second section of the second subelement 4. The connecting subsection 10 thus connects the outer subsection 8 to the second section 7 and extends along the radial axis R of the roller 1. The roller 1 thus comprises at least one connecting subsection 11.

FIG. 8 shows a further embodiment according to which at least one intermediate subsection 11 is arranged along the radial axis R of the roller 1 between the outer subsection 8 and the second section 7. According to this advantageous embodiment, two intermediate subsections 11 are provided. The intermediate subsections 11 are essentially the same as the outer subsection 8, i.e. they also have an essentially rectangular cross-sectional area and merge inwards in the radial direction into a connecting subsection 10. The respective connecting subsection 10 extends along the radial axis R and is centred along the height axis H.

The intermediate subsections 11 have the same extension along the height axis H as the outer subsection 8 and are also arranged in the centre with respect to the radial sectional axis S in the same way as the outer subsection 8. An intermediate subsection 11 and the connecting subsection 10 arranged thereon thus also have an essentially T-shaped cross-sectional area.

According to the embodiment shown in FIG. 8, 3 connecting subsections are provided. A first connecting subsection 11 connects the outer subsection 8 to a first intermediate subsection 11. A further connecting subsection 11 connects the first intermediate subsection 11 to a second intermediate subsection 11. A third connecting subsection 10 connects the second intermediate subsection 11 to the second section 7, which is radially furthest inwards. This results in a structure with three adjacent T-shaped cross-sectional areas. This configuration results in spaces between the outer subsection of second subelement 8 and the intermediate subsection 11 between the intermediate subsections and between the second section and the intermediate subsection 11. These spaces are filled by the first subsection of second subelement 2.

The first subelement 2 has a rolling subsection 12 extending along the circumferential direction U of the roller 1, which comprises the rolling surface 3. The rolling subsection 12 is arranged at least partially on the upper surface 9 of the first lower section 8. FIGS. 5 to 8 clearly show that the rolling subsection 12 extends along the height axis H beyond the outer subsection 8. The rolling subsection 12 merges into a side section 16 on each side of the roller 1. These side sections 16 surround the side faces 15 or are bordered by the side faces 15. Starting from the side sections 16, at least one engagement section 13 extends on a respective side of the second subelement 4. There is thus at least one pair of engagement sections 13, which are opposite each other along the height axis H and are separated from each other by a connecting subsection 10. The engagement sections 13 are arranged in the above-mentioned intermediate spaces.

According to the embodiment of FIGS. 5, 6 and 7, there is a pair of engagement sections 13. Accordingly, one engagement section 13 is arranged on each side between the outer subsection 8 and the second section 7.

According to the embodiment shown in FIG. 8, an engagement section 13 is arranged between the outer subsection 8 and the first intermediate subsection 11 on each side. Another pair of engagement portions 13 is arranged between the first intermediate subsection 11 and the second intermediate subsection 11. Finally, a pair of engagement sections 13 is provided between the second intermediate subsection 11 and the second section 7.

The at least one pair of engagement sections 13, the rolling subsection 12 and the side section 16 form the first part element in one piece. Similarly, the first section 6, comprising the outer subsection of second section 8, at least one connecting subsection of first section 10 and the second section 7 form the second subelement 4 in one piece. This can be seen, for example, in FIGS. 3 and 4.

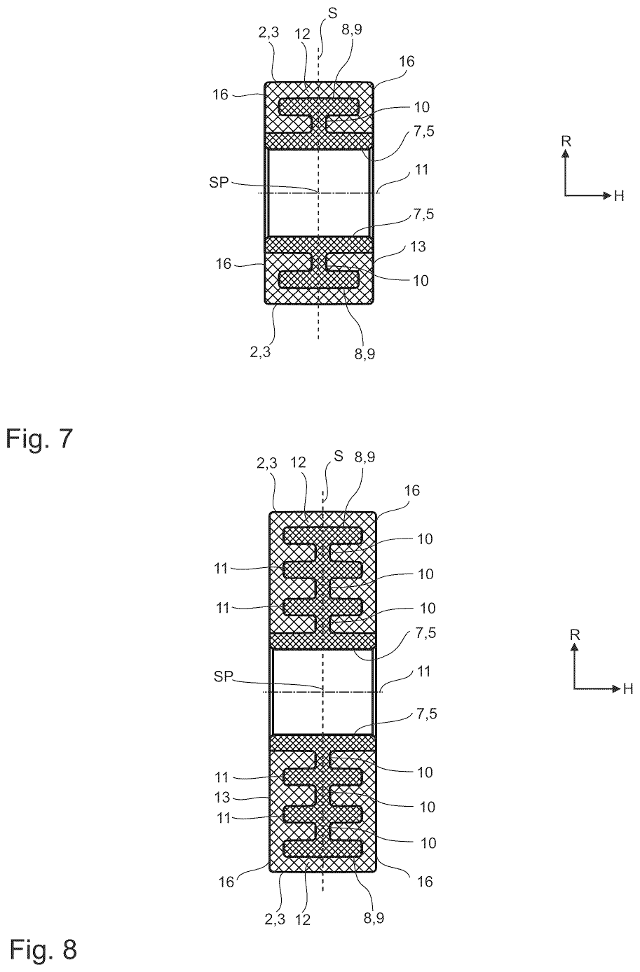

According to the embodiment shown in FIG. 7, the rolling subsection 12, the engagement sections 13, the outer subsection 8, the connecting subsection 11, the second section 7 and the side sections 16 have a substantially equal wall thickness, with the wall thicknesses of the rolling subsection 12, the engagement sections 13, the outer subsection 8 and the second section 7 extending along the radial axis R. The wall thicknesses of the connecting lower section 11 and the side sections 16 extend along the height axis H.

According to the embodiment shown in FIG. 8, the rolling subsection 12, the engagement subsections 13, the outer subsection 8, the connecting subsections 11, the intermediate subsections 11, the second section 7 and the side section 16 have a substantially equal wall thickness, wherein the wall thicknesses of the rolling subsection 12, the engagement subsections 13, the outer subsection 8, the intermediate subsections 11 and the second section 7 extend along the radial axis R. The wall thicknesses of the connecting subsections 11 and the side sections 16 extend along the height axis H.

FIGS. 5 and 6 show an embodiment in which the second section 7 of the second subelement 4 has two opposite end regions 14 along the height axis H. Each end region 14 has a step-like design. The respective step points outwards. The first part element 2 or the side sections 16 rest against the step-like end regions 14. The two end regions 14 include a centre section 17.

According to the embodiment shown in FIG. 5, the rolling subsection 12, the engagement sections 13, the outer subsection 8, the connecting subsection 11, the centre section 17 and the side sections 16 have essentially the same wall thickness, with the wall thicknesses of the rolling subsection 12, the engagement sections 13, the outer subsection 8 and the centre section 17 extending along the radial axis R. The wall thicknesses of the connecting lower section 11 and the side sections 16 extend along the height axis H.

In contrast to FIG. 5, the connecting subsection 11 in FIG. 6 has a greater wall thickness. This can be useful for greater load requirements. According to the embodiment according to FIG. 6, the rolling subsection 12, the engagement sections 13, the outer subsection 8, the centre section 17 and the side sections 16 have a substantially equal wall thickness, wherein the wall thicknesses of the rolling subsection 12, the engagement sections 13, the outer subsection 8 and the centre section 17 extend along the radial axis R. The wall thicknesses of the side sections 16 extend along the height axis H.

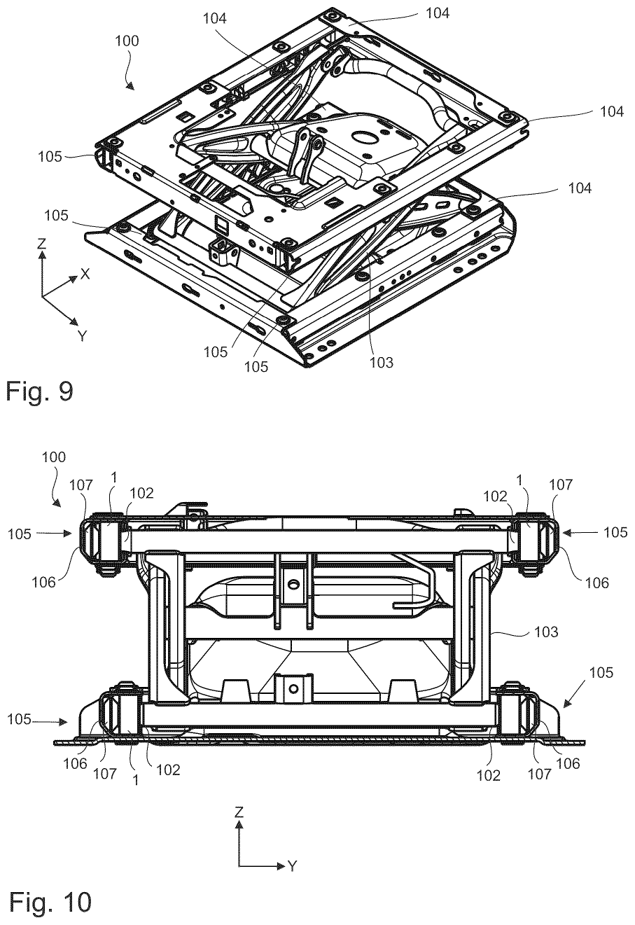

FIGS. 9 and 10 show a vehicle seat-base 100. This extends along the height axis Z, a width axis Y and a longitudinal axis X. The vehicle seat-base 100 has a scissor-type frame 103, which connects an upper part of the vehicle seat to a lower part of the vehicle seat. The ends of the respective scissors of the scissor-type frame 103 are mounted on the one hand by means of a fixed bearing 104 and on the other hand by means of a floating bearing 105 in order to ensure a bump movement and a rebound movement. A floating bearing 105 comprises a roller guide 103. This roller guide 103 comprises a rail element 106, in which a roller 1 is arranged.

FIG. 10 shows a bearing element 102 in the form of a bearing pin, which passes through the roller 1 and is connected to a guide element 107. The guide element 107 comprises a surface which is inclined relative to the width axis Y. The guide rail element 106 comprises a section which also runs at an angle relative to the width axis Y. The guide element 107 rests against this section in such a way that the roller 1 is pressed upwards and can roll on an upper surface of the guide rail element 106.

All features disclosed in the application documents are claimed to be essential to the invention, provided that they are new, either individually or in combination, compared to the prior art.

### LIST OF REFERENCE SIGNS

1 Roller
2 First subelement
2a Front face of the first subelement
3 Rolling surface
4 Second subelement
5 Mount
6 First section of the second subelement
7 Second section of the second subelement
7a Inner surface
7b Front face of the second first subelement
8 Outer subsection of second subelement
9 Upper surface of outer subsection
10 Connecting subsection of first section
11 Intermediate subsection
12 Rolling subsection
13 End wall
14 End regions of the second section
15 Side faces
16 Side section of the first part element
17 Centre section
100 Vehicle seat-base
101 Roller guide
102 Bearing element
103 Scissor-type frame
104 Fixed bearing
105 Floating bearing
106 Guide rail element
107 Guide element
H Height axis
M Centre axis
S Radial sectional axis
SP Intersection of the radial sectional axis and the centre axis
R Radial axis
U Circumferential direction
X Longitudinal axis of the vehicle seat-base
Y Width axis of the vehicle seat-base
Z Height axis of the vehicle seat-base

What is claimed is:

1. A roller, in particular for a vehicle seat-base, comprising a first subelement, which comprises a rolling surface, and a second subelement, which forms a mount for a bearing element, wherein
the second subelement has a first section which is at least partially enclosed by the first subelement in such a way that there is a positive locking between the first subelement and the second subelement.

2. The roller according to claim 1, wherein
the first subelement and the second subelement consist of different materials, wherein the material of the first subelement is selected such that it has a higher coefficient of friction than the material of the second subelement, wherein the roller is produced by means of a multi-component injection moulding process.

3. The roller according to claim 1, wherein
the roller comprises a centre axis (M) which extends along a height axis (H), wherein the roller has a radial sectional axis(S) which extends along a radial axis (R) of the roller, wherein an intersection (SP) of the radial sectional axis(S) and the centre axis (M) lies at half the height extension of the roller, wherein the first section of the second subelement is symmetrical with respect to the radial sectional axis(S).

4. The roller according to claim 1, wherein
the second subelement has a second section which is of hollow-cylindrical design and forms the mount for the bearing element, wherein the second section of the second subelement has a height extension which essentially corresponds to the height extension of the roller.

5. The roller according to claim 1, wherein
the first section of the second subelement has an outer subsection extending along a circumferential direction (U) of the roller, which comprises an upper surface that extends essentially parallel to the rolling surface of the first subelement and is arranged along the radial axis (R) of the roller closer to the centre axis (M) of the roller than the rolling surface, wherein the outer subsection is substantially hollow-cylindrical, wherein the outer subsection has a height along the height axis (H) of the roller which is smaller than the height of the roller, wherein the first subelement at least partially encloses the outer subsection.

6. The roller according to claim 5, wherein
the outer subsection is connected to the second section by means of a connecting subsection of the first section, wherein the connecting subsection extends along the radial axis (R) of the roller.

7. The roller according to claim 5, wherein
at least one intermediate subsection is arranged along the radial axis (R) of the roller between the outer subsection and the second section, wherein the at least one intermediate subsection has essentially the same configuration as the outer subsection, wherein the outer subsection is connected to the at least one intermediate subsection by means of a connecting subsection, wherein the at least one intermediate subsection is connected to the second section by means of a connecting section.

8. The roller according to claim 6, wherein
the first subelement has a rolling subsection extending along the circumferential direction (U) of the roller and comprising the rolling surface, wherein the rolling subsection is arranged at least partially on the upper surface of the first subsection, wherein the first subelement has at least one pair of engagement sections opposite each other along the height axis (H), which are separated from each other by a connecting subsection.

9. The roller according to claim 8, wherein
at least the rolling subsection, the engagement sections and the outer subsection have substantially the same wall thickness, wherein at least the rolling subsection, the engagement sections, the outer subsection and the at least one intermediate subsection have substantially the same wall thickness, wherein at least the rolling subsection the engagement sections, the outer subsection and the at least one connecting subsection have essentially the same wall thickness, wherein at least the rolling subsection, the engagement sections, the outer subsection, the at least one intermediate subsection and the at least one connecting subsection have essentially the same wall thickness.

10. The roller according to claim 4, wherein
the second section of the second subelement has two opposite end regions along the height axis (H), wherein each of the end regions is formed in a step-like manner, wherein the first subelement rests against the step-like end regions.

11. A vehicle seat-base with a roller guide comprising at least one roller according to claim 1.

12. The vehicle seat with a vehicle seat-base according to claim 11.
